(19) United States
(12) Patent Application Publication
(10) Pub. No.: US 2009/0290749 A1
(43) Pub. Date: Nov. 26, 2009

(54) DYNAMIC ELECTRO-ACOUSTIC TRANSDUCER AND EARPHONE

(75) Inventors: Alwin Harms, Wedemark (DE); Elmar Schulze, Lehrte (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SENNHEISER ELECTRONIC GMBH & CO. KG, Wedemark (DE)

(21) Appl. No.: 12/470,123

(22) Filed: May 21, 2009

(30) Foreign Application Priority Data
May 23, 2008 (DE) 102008024816.9

(51) Int. Cl. H04R 1/00

(52) U.S. Cl. 381/400

(57) ABSTRACT

There is thus provided a dynamic electro-acoustic transducer having a moving coil (100) with a coil exit location (110) and a first and a second feed line (200, 300). The first and second feed lines (200, 300) have first ends (210, 310) for coupling to the coil exit location (110), an intermediate portion (250, 350) and second ends (220, 320). The intermediate portions (250, 350) of the first and second feed lines (200, 300) are substantially parallel to a tangent at the moving coil (100).

The invention concerns a dynamic electro-acoustic transducer and an earphone.

Particularly in the case of dynamic electro-acoustic transducers, a connection for the wire of the coil has to be provided.

DE 42 43 308 C2 discloses a dynamic electro-acoustic transducer having a diaphragm carrying the moving coil. The transducer also has two feed lines for the moving coil. In that arrangement the feed lines are in the form of an asymmetrical S-shaped meander. The S-shaped meanders of the feed lines are intended to serve to increase the maximum stroke.

Particularly in the case of dynamic transducers of small dimensions the known wiring arrangement of the feed line reaches its limits. For example it is not possible to guarantee the required continuous oscillation loading of the wires without the wires tearing away. In addition, upon a reduction in the size of the transducer and thus the wire deformation zone, it can happen that the low flexibility of the wires has an influence on the overall flexibility of the transducer so that the transducer for example is damped on one side more than on the other side.

The object of the present invention is to provide a dynamic electro-acoustic transducer and an earphone, which have a higher level of transducer efficiency.

That object is attained by a dynamic electro-acoustic transducer as set forth in claim 1.

Thus there is provided a dynamic electro-acoustic transducer having a moving coil with a coil exit location and a first and a second feed line. The first and second feed lines have first ends for coupling to the coil exit location, an intermediate portion and second ends. The intermediate portions of the first and second feed lines are substantially parallel to a tangent at the moving coil.

In accordance with an aspect of the invention the first and second feed lines are of such a configuration that they act at least portion-wise as a torsion bar.

In accordance with a further aspect of the present invention the intermediate portions are twisted upon a movement of the moving coil.

In accordance with still a further aspect of the present invention the first ends of the first and second feed lines move relatively little upon movement of the moving coil.

The invention also concerns an earphone with an above-described dynamic electro-acoustic transducer.

Further configurations of the invention are subject-matter of the appendant claims.

Advantages and embodiments by way of example of the invention are described hereinafter with reference to the drawing.

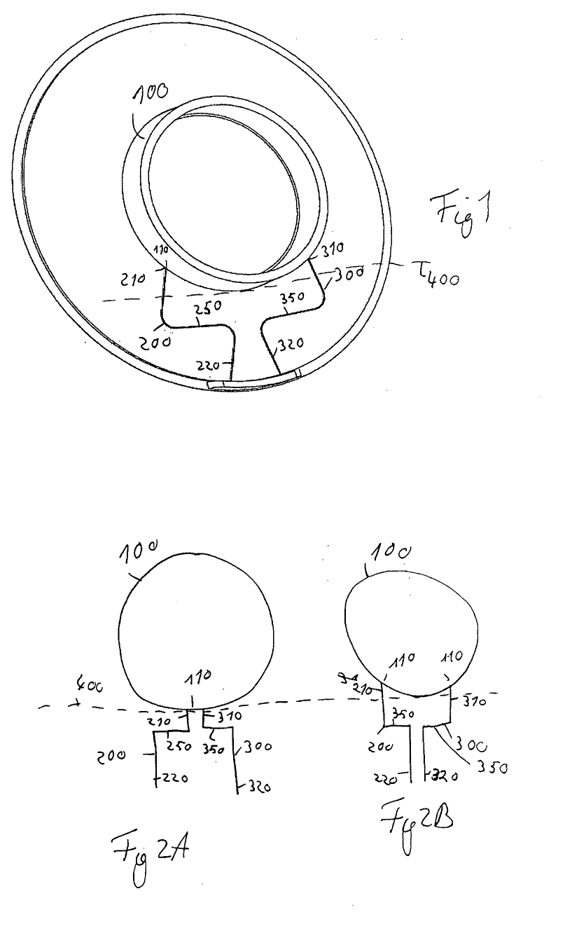

FIG. 1 shows a diagrammatic view of a dynamic electro-acoustic transducer in accordance with a first embodiment, and

FIGS. 2A and 2B show further views of a dynamic electro-acoustic transducer in accordance with a second embodiment.

FIG. 1 shows a diagrammatic view of a dynamic electro-acoustic transducer in a first embodiment. The transducer has a moving coil 100 and first and second feed lines 200, 300. The feed lines are (electrically) coupled at their first end 210, 310 to the moving coil 100 and the moving coil exit location respectively and are coupled at their second end 220, 320 to a casing 400. The first ends 210, 310 of the feed lines 200, 300 can extend substantially parallel and the second ends 220, 320 of the feed lines 200, 300 are also substantially parallel. A respective intermediate portion 250, 350 is provided between the first and second ends 210, 310; 220, 320 of the feed lines 200, 300. That intermediate portion 250, 350 can optionally be at an angle of about 90° to the first and second ends 210, 310; 220, 320 of the feed lines. By virtue of that configuration of the feed line the feed line can act as a torsion bar. The consequence of this is that no bending but only a torsional movement occurs in the region of the intermediate portion when the moving coil 100 moves. In particular in that case the intermediate portions 250, 350 are twisted and move only slightly. Optionally the intermediate portions 250, 300 are substantially parallel to a tangent 400 at the moving coil 100.

FIGS. 2A and 2B show diagrammatic views of a dynamic electro-acoustic transducer in a second embodiment. The dynamic transducer has a moving coil 100, a moving coil exit location 110 and two feed lines 200, 300. The feed lines have a first end 210, 310 coupled to the moving coil 100. The feed lines also have an intermediate portion 250, 350 and second ends 220, 320. The first ends 210, 310 and the second ends 220, 320 of the feed lines 200, 300 can be parallel to each other. The intermediate portions 250, 350 are preferably parallel to a tangent 400 at the moving coil 100. That configuration of the feed line 200, 300 can implement a torsion bar so that the intermediate portions of the feed lines are substantially only twisted but not bent.

The configuration of the feed lines in the first and second embodiments make it possible to avoid mode formation so that this now does not have any negative influence on the frequency response characteristic of the transducer. The configuration of the feed line also makes it possible to prevent the flexibility of the wires being able to influence the overall flexibility of the transducer. In addition it is possible in that way to achieve a reduction in a single-sided system damping effect.

The service life of the connecting wires of the oscillating line and thus the entire transducer is increased.

The invention concerns the concept that a maximum mechanical loading of wires in relation to a torsional stress is very much higher than in relation to a bending stress. In the transducer in the first and second embodiments an upward and downward movement of the coil provides that a part of the required mechanical deformation work occurs due to the intermediate portions or the horizontal portions of the wire due to a torsional effect in respect of those portions.

Accordingly a critical bending component at the coil exit location and the wire fixing at the outer edge of the diaphragm can be substantially reduced. To increase the length of the torsion bar (the intermediate portion) the wires can be of a suitable configuration.

In addition the wire length between the two clamping locations is increased so that the overall stiffness of the system is reduced and it is thus possible to avoid one-sided damping of the system by one of the feed lines. If the feed lines are of a sharp-edged configuration the wire modes can then be further limited.

1. A dynamic electro-acoustic transducer having
a moving coil with a coil exit location; and
a first and a second feed line with first ends for coupling to the coil exit location, an intermediate portion and second ends,
wherein the intermediate portions of the first and second feed lines are substantially parallel to a tangent at the moving coil.

2. A transducer as set forth in claim 1 wherein the first and second feed lines are of such a configuration that they act at least portion-wise as a torsion bar.

3. A transducer as set forth in claim 1 wherein the intermediate portions are twisted upon a movement of the moving coil.

4. A transducer as set forth in claim 1 wherein the first ends of the first and second feed lines move relatively little upon movement of the moving coil.

5. An earphone having a dynamic electro-acoustic transducer as set forth in claim 1.
